(19) United States
(12) Patent Application Publication
(10) Pub. No.: US 2014/0337191 A1
(43) Pub. Date: Nov. 13, 2014

(54) RECYCLING COLLECTION PAYOUT

(71) Applicant: Bernard L. Senser, Columbus, OH (US)

(72) Inventor: Bernard L. Senser, Columbus, OH (US)

(73) Assignee: Aluminum Can Bank of America, Columbus, OH (US)

(21) Appl. No.: 13/892,721

(22) Filed: May 13, 2013

(51) Int. Cl. G06Q 30/02; G06Q 10/00; G06Q 20/08

(52) U.S. Cl. CPC G06Q 30/0237; G06Q 20/08; G06Q 10/30
USPC 705/35

(57) ABSTRACT

One or more embodiments of techniques or systems for recycling collection payout are provided herein. In some embodiments, a user can place objects into a recycling collection payout system, the system sorts or identifies recyclable objects, gathers or stores the recyclable objects, and pays the user for the recyclable objects. The user can be paid via a payout component that provides a user with a variety of options, such as a gift card, a coupon, payout to an account, etc. A recycling collection payout system can compact, bale, or store recyclable objects. Additionally, a status of the recycling collection payout system can be monitored via a remote diagnostic component to determine whether the system is jammed, close to being full, or low on funds. In this manner, a user can be incentivized to bring recyclable material, such as metal, aluminum, steel, or plastic, for collection.

### BACKGROUND

Recycling generally utilizes waste materials to produce ‘renewed’ materials for use in new products and can mitigate waste of potentially useful materials, consumption of fresh raw materials, energy usage, air pollution, and water pollution, among other things. Materials that can be recycled include glass, paper, metal, aluminum, steel, plastic, textiles, electronics, etc. Waste to be recycled can be brought to a collection center or picked up from the curbside, then sorted, cleaned, and reprocessed. However, garbage collection services or waste management services may not offer pick-up services at the curb for homeowners. Although recycling drop-off centers may be available, some people do not bother with the hassle.

### SUMMARY

This summary is provided to introduce a selection of concepts in a simplified form that are further described below in the detailed description. This summary is not intended to be an extensive overview of the claimed subject matter, identify key factors or essential features of the claimed subject matter, nor is it intended to be used to limit the scope of the claimed subject matter.

One or more embodiments of techniques or systems for recycling collection payout are provided herein. Often, materials are thrown in the garbage that can otherwise be used to manufacture ‘renewed’ material. For example, aluminum beer or soda bottles or cans can be used as scrap metal, but are often thrown in the trash. One or more embodiments of techniques or systems for recycling collection payout can mitigate waste by incentivizing users to bring recyclables to a recycling collection payout system. In other words, the recycling collection payout system can pay users to bring recyclable material to the system for collection. In some embodiments, a user can deposit one or more objects into a compartment or bin where the objects are received. Objects that are not recyclable or compatible with the recycling collection payout system can be sorted out or returned to the user. When the user is finished depositing the objects, qualifying objects or recyclable objects can be counted or quantified. The user can then select a payment option or payout option from a user interface, and the system can pay the user using the option selected.

In some embodiments, the payout option can comprise at least one of a donation to a charity, a cash payout, a deposit to a bank account, a credit to a credit card, a gift card, a coupon, or a credit linked to an account, such as PayPal, for example. In a scenario where an account is linked, a server component can use account information from the user to associate the user or a payout with a corresponding user account.

Additionally, the recyclable objects received by a recycling collection system can be compacted, baled, or stored. A remote diagnostic component can be used to monitor a status of the recycling collection system. For example, the remote diagnostic component can alert an administrator when a storage unit is at a certain capacity, a level of funds is low, or if there is a jam or a break into the machine or system.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 is an illustration of a component diagram of an example system for recycling collection payout, according to some embodiments.

FIG. 2 is an illustration of an example system for recycling collection payout, according to some embodiments.

FIG. 3 is an illustration of a schematic diagram of an example system for recycling collection payout, according to some embodiments.

FIG. 4 is an illustration of an example system for recycling collection payout, according to some embodiments.

FIG. 5 is an illustration of a flow diagram of an example method for recycling collection payout, according to some embodiments.

FIG. 6 is an illustration of a computer-readable medium or computer-readable device comprising processor-executable instructions configured to embody one or more of the provisions set forth herein, according to some embodiments.

FIG. 7 is an illustration of a computing environment where one or more of the provisions set forth herein are implemented, according to some embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

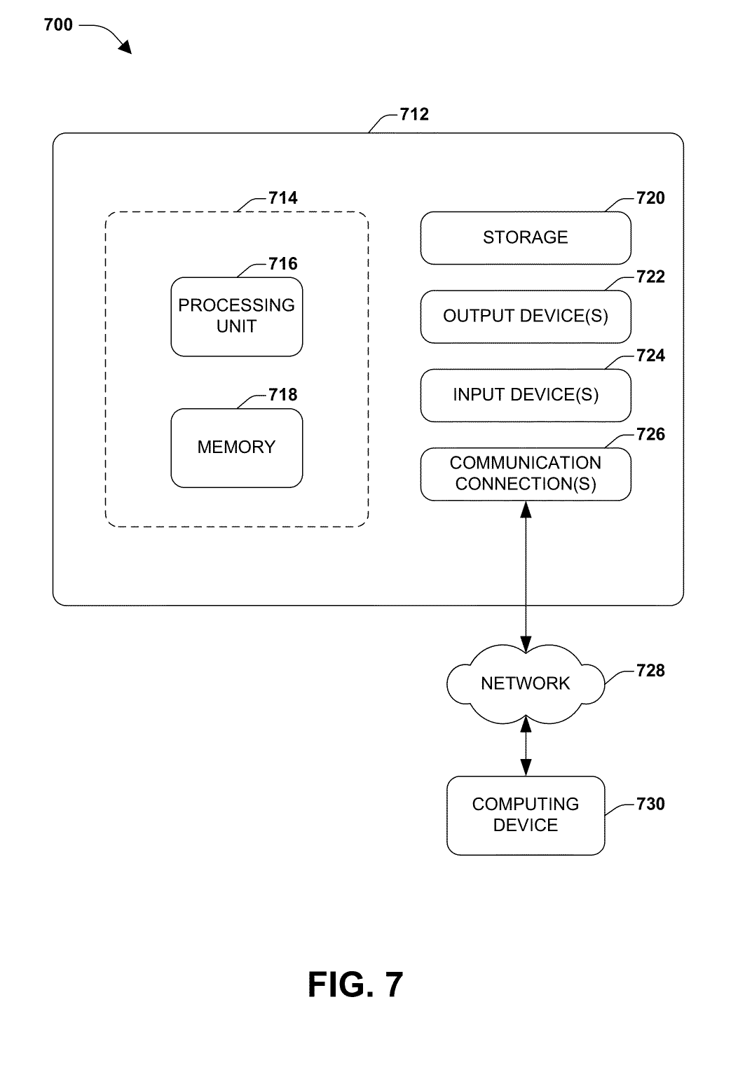

It will be appreciated that for some of the figures herein, one or more boundaries, such as boundary 714 of FIG. 7, for example, are drawn with different heights, widths, perimeters, aspect ratios, shapes, etc. relative to one another merely for illustrative purposes, and are not necessarily drawn to scale. For example, because dashed or dotted lines are used to represent different boundaries, if the dashed and dotted lines were drawn on top of one another they would not be distinguishable in the figures, and thus are drawn with different dimensions or slightly apart from one another, in some of the figures, so that they are distinguishable from one another. As another example, where a boundary is associated with an irregular shape, the boundary, such as a box drawn with a dashed line, dotted lined, etc., does not necessarily encompass an entire component in some instances. Conversely, a drawn box does not necessarily encompass merely an associated component, in some instances, but encompasses at least a portion of one or more other components as well.

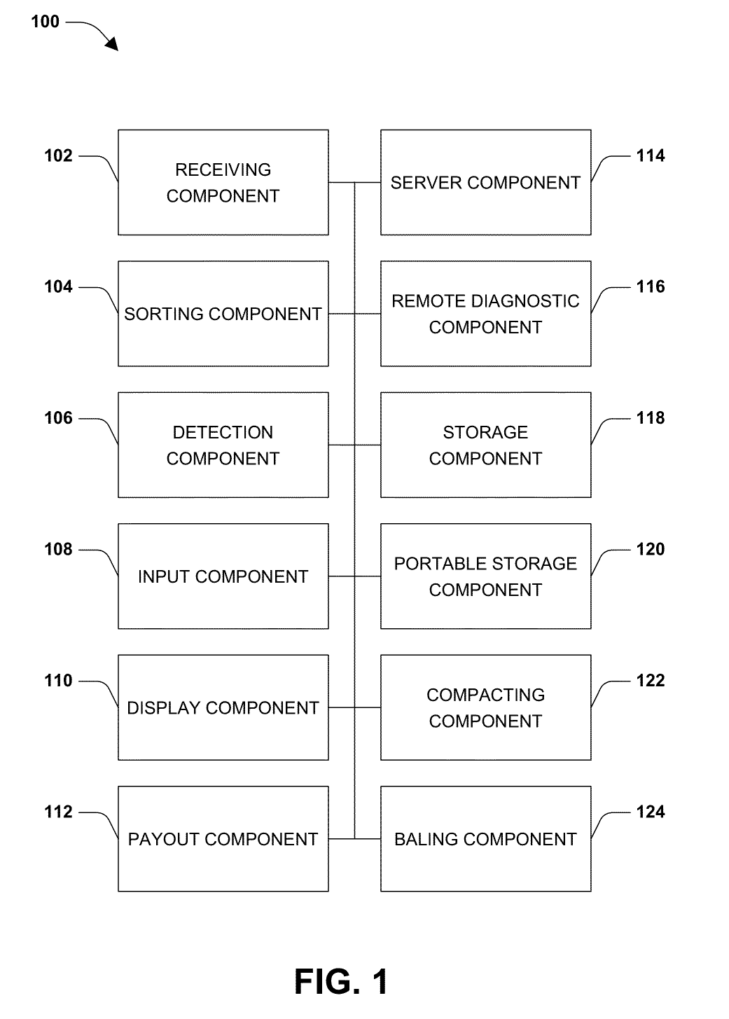

FIG. 1 is an illustration of a component diagram of an example system 100 for recycling collection payout, according to some embodiments. The recycling collection payout system or ‘system’ 100 can comprise a receiving component 102, a sorting component 104, a detection component 106, an input component 108, a display component 110, a payout component 112, a server component 114, a remote diagnostic component 116, a storage component 118, a portable storage component 120, a compacting component 122, or a baling component 124. A recycling collection payout system, such as system 100, can be configured to accept one or more different recyclable objects or one or more recyclable materials. For example, the system 100 can be configured to accept at least one of aluminum, glass, steel, plastic, polyethylene terephthalate (PET), etc.

It will be appreciated that a “can”, such as an “aluminum can” may be an object in some scenarios, and vice versa in others. In some embodiments, a user can bring one or more objects to the system 100, for example, because the user can be incentivized to be paid by the payout component 112 of system 100. The display component 110 can be configured to scroll advertising messages, such as “We pay for your cans!” or “Earn five cents per can you recycle” to incentivize users to recycle at the recycling collection payout system or system 100. Accordingly, the display component 110 can display a price breakdown or advertising based at least in part on a location of the system 100. For example, if the system 100 is located in a ritzy or wealthy area, the display component 110 could be configured to display messages related to environmental health issues, etc. On the other hand, if the system 100 is located in a less wealthy area, the display component 110 can be configured to display the payout cost per can. In some embodiments, the display component 110 can be configured to prompt a user to determine whether or not the user was influenced by advertising or how the user decided to bring recycling to the system 100. For example, the display component 110 can be configured to display a list of options related to how a user learned about the recycling collection payout system, such as a menu listing the following: “saw an advertisement on television”, “word of mouth”, “friends and family”, “saw the display component 110 scrolling prices”, “skip this question”, “other”, etc. The input component 108 can be configured to receive a marketing input from the user, as will be described herein.

In some embodiments, the receiving component 102 can be configured to receive one or more objects or one or more received objects from a user. In other words, the receiving component 102 can be a compartment, bin, chute, container, box, etc. where a user places one or more objects that may potentially be recycled. It will be appreciated that of the one or more received objects received by the receiving component 102 one or more of at least some of the one or more received objects may be recyclable objects and one or more of at least some of the one or more received objects may be non-recyclable objects. What this means is that a user may place recyclable material as well as non-recyclable material in the receiving component 102. It will be appreciated that an object classified, sorted, or identified as non-recyclable may be capable of being recycled at other systems configured for that corresponding material. In other words “non-recyclable” is merely used as an identifier herein, not as a determination as to whether a corresponding object can actually be recycled.

In some embodiments, at least some of the one or more received objects are at least one of sorted or identified. It will be appreciated that the sorting may occur at least one of before, after, throughout, during, or before and after identification. For example, the sorting component 104 can comprise at least one of a robotic arm, a vacuum, a vacuum blower, a vacuum arm, a conveyor belt, one or more magnets, etc. In some embodiments, the sorting component 104 sorts at least some of the one or more received objects by using the vacuum or vacuum pump to lift one or more recyclable objects away from one or more of the non-recyclable objects. In some embodiments, the sorting component 104 can be configured to sort one or more qualifying objects or one or more recyclable objects using a conveyor belt and a magnet. For example, the sorting component 104 can transport at least some of the one or more received objects along a conveyor belt and separate at least some of the one or more recyclable objects, such as steel (e.g., which can be magnetic), from one or more received objects. In some embodiments, the sorting component 104 can comprise a grate filter configured to sift at least some of the one or more received objects through holes in the grate filter, thereby separating one or more recyclable objects from at least some of the one or more received objects. In some embodiments, the sorting component 104 can be configured to sort at least some of the one or more received objects into one or more categories of recyclable objects. For example, if the system 100 can be configured to recycle glass and metal, the sorting component 104 can be configured to separate at least some of the one or more received objects into a first category for glass, a second category for metal, and a third category for non-recyclable or non-accepted objects.

In some embodiments a material of at least some of the one or more received objects can be identified prior to sorting. For example, a detection component 106 can be configured to identify a material of a received object. When a recyclable object is identified, the sorting component 104 can be configured to sort the recyclable object from at least some of the one or more received objects. As an example, when a user loads one or more objects into the system 100, the detection component 106 can identify or detect a material for at least some of the one or more received objects. The sorting component 104 can then sort at least some of the one or more received objects based at least in part on the material or material type detected or identified by the detection component 106. If a user places three objects into a receiving component 102, such as a metal can, a first glass bottle, and a second glass bottle, the detection component 106 can identify a first metal object, a second glass object, and a third glass object. The sorting component 104 can thus sort the metal can and glass bottles accordingly. For example, the sorting component 104 can comprise a robotic arm that separates the metal can from the glass bottles by picking up the metal can and moving the metal can to another area, such as within a storage component 118. As another example, the sorting component 104 can sort at least some of the one or more received objects by using a grate filter, thereby sorting objects by size.

In some embodiments, the sorting component 104 can be configured to return at least some of at least one of the received objects, non-recyclable objects, non-accepted objects, etc. to the user. Alternatively, the sorting component 104 can be configured to separate at least some of at least one of the received objects, non-recyclable objects, non-accepted objects, etc. and store them for waste management, for example. In other words, the sorting component 104 can return non-desired objects to a user or trash the non-desired objects. A non-desired object can be a received object that is not identified or sorted as a recyclable object by the sorting component 104.

The detection component 106 can comprise a bar code reader, one or more magnets, an image sensor, a stock keeping unit (SKU) reader, a laser, laser reader, image recognition technology. In some embodiments, the detection component 106 can be configured to identify a material for at least some of the one or more received objects or sorted objects. When materials for at least some of the respective objects are determined or identified, the detection component 106 can identify a number of recyclable objects. The number of recyclable objects can be based at least in part on types of materials the system 100 can be configured to recycle or at least some of the one or more recyclable objects, for example. That is, if a system can be configured to recycle aluminum, the detection component 106 can be configured to count a number of aluminum objects of at least some of the one or more received objects.

In some embodiments, the detection component 106 can be configured to at least one of identify, determine, or detect a material of an object by reading at least one of a bar code, a SKU code, a universal product code (UPC), etc. on a received object. For example, an aluminum soda can may have a UPC code that identifies the packaging to be an aluminum can, rather than a plastic bottle. In this scenario, the detection component 106 can be configured to identify the can as aluminum based at least in part on the UPC code, for example. In some embodiments, image recognition may be used by the detection component 106 to identify a received object or a material associated therewith. For example, a can of soup may have a label with a logo attached to the can. Here, the detection component 106 could associate the can with metal, such as by scanning the logo from the can of soup, for example. In some embodiments, a composition of a material can be determined based at least in part on a brand, logo, identifying mark, UPC code, SKU code, bar code, etc. For example, a Coke can may comprise X % aluminum, etc. In some embodiments, the payout component 112 can be configured to adjust a payout based at least in part on at least one of the bar code, a SKU code, UPC, composition of a material, etc.

In some embodiments, the input component 108 can be configured to accept one or more inputs from a user, such as a payout option, for example. The input component 108 can comprise a touch screen, a touch pad, a user interface, one or more buttons, etc. The input component 108 can be configured to receive one or more selections from a user based at least in part on a menu displayed by the display component 110. In some embodiments, the input component 108 can be configured to receive a finished loading input from a user and the display component 110 prompts the user for the finished loading input while the user is loading one or more received objects into the receiving component 102, for example. In other words, the input component 108 waits for the user to alert the system 100 that he or she has finished loading recyclables into the receiving component 102 of the system 100. In this scenario, the display component 110 could be configured to prompt the user to hit a button on the input component 108 when finished loading the recyclables. Additionally, the input component 108 can comprise a touchpad configured to accept one or more digits from a user. The user can enter a zip code and the server component 114 can note a volume of recyclable objects associated with that zip code. In this way, future recycling collection payout systems can be established based on the volume and the zip code.

The display component 110 can be configured to prompt a user for one or more inputs, such as a payout option, which will be described herein. In some embodiments, the display component 110 can be configured to display at least one of a number of recyclable objects received. For example, if the user has placed a metal can and two glass bottles in the receiving component 102, the display component 110 can display a count, such as Metal: 1, Glass: 2 in real time. The number of recyclable objects received can be displayed when the user has finished loading the received objects into the receiving component 102, hit a button that alerts the system that he or she is finished loading (e.g., a finished loading input for the input component 108), and the detection component 106 identifies the respective recyclable items. In some embodiments, the display component 106 can be configured to display a running total or running payout after the user has finished loading the received items.

In some embodiments, the display component 110 can be configured to play a movie or a video to a user. The movie or the video can be based at least in part on the location of the recycling collection payout system, an identifier on a received object, such as a logo, a SKU code, a bar code, a UPC, etc. In this way, advertising or other media can be used to target a user based at least in part on what the user is recycling. For example, an advertisement for Soda B could be played by the display component 110 when Soda A is detected. Alternatively, when Soda A is detected, the advertisement can be for Soda A. In some embodiments, the display component 110 can be configured to play a movie, such as a children's movie or a cartoon to entertain children while a parent is loading the system 100. For example, an audio detection component (not shown) can be configured to detect one or more sounds and determine whether or not a child is present. If the audio detection component determines a child is present, the audio detection component can prompt the display component 110 to play the children's movie or cartoon.

In some embodiments, the server component 114 enables the system 100 to have connectivity to a source, such as the internet, to determine a date, a time, a weather forecast, or connect to a second server component for another recycling collection payout system, etc. The display component 110 can be configured to display at least one of the date, time, weather forecast, etc. Additionally, the display component 110 can be configured to display a capacity status of a storage component 118 or 120 associated with the system 100. In some embodiments, the display component 110 can be configured to display a capacity status of a second storage component associated with a second system based at least in part on connectivity between the server component 114 and a second server component. When a first server component is connected to a second server component, the two server components can exchange information, such as a status of a corresponding recycling collection payout system, storage component, etc. For example, if a recycling collection payout system is at or near capacity (e.g., over a threshold capacity), that system could display a capacity status of one or more other storage components of one or more other recycling collection payout systems and/or corresponding locations. In other words, if a user brings recyclables to a first recycling collection payout system, but the first recycling collection payout system is at least one of full, close to full, at a threshold, malfunctioning, etc., the server component 114 of the first recycling collection payout system can connect to one or more other server components of one or more other recycling collection payout systems to poll those other systems for a capacity status of storage components for at least some of the one or more other recycling collection payout systems.

A display component 110 of the first recycling collection payout system can be configured to display respective capacity statuses for at least some of the one or more other recycling collection payout systems. Additionally, the display component 110 can be configured to provide suggestions for alternative recycling collection payout systems. For example, if a first recycling collection payout system is full or malfunctioning, etc., the display component 110 can be configured to suggest a second recycling collection payout system that is nearby. In other words, a suggestion can be made based at least in part on a location of a second recycling collection payout system. In some embodiments, the server component 114 can be configured to create the suggestion to the second recycling collection payout system and prompt the display component 110 to display the suggestion. In some embodiments, the server component 114 can be configured to create a suggestion to a second recycling collection payout system based at least in part on a capacity status of a second recycling collection payout system. In other words, the server component 114 can suggest a second recycling collection payout system that has a storage component that is not as full or functioning, for example. In some embodiments, a suggestion component (not shown) can be configured to create the suggestion, rather than the server component 114, for example.

In some embodiments, the server component 114 can be configured to associate or record a timestamp when a user initiates a recycling load. For example, the server component 114 could record the timestamp when a finished loading input is received, how many recyclable objects were received, a volume associated with the recyclable objects, etc. In this way, recycling trends can be tracked in a recycling database (not shown) or by the server component 114, for example. This would enable a company, for example, to better determine a schedule for maintaining the recycling collection payout system 100. For example, if usage is historically higher on Mondays, recycling pickup could be scheduled for the system 100 on a following day, such as Tuesday. In some embodiments, the server component 114 can be configured to send at least one of an alert, email, text message, automated phone call, fax, etc. to a recipient based at least in part on a capacity status of a storage component 118 or 120 of the system 100. As an example, when the storage component 118 of system 100 reaches 75%, the server component 114 can send an automated email to alert maintenance that a pickup should be scheduled. Additionally, the server component 114 could track historical usage and infer a maintenance schedule based at least in part on the historical usage. The server component 114 can be configured to connect to or post to a social networking site to alert one or more friends of the user that the user was recycling.

In some embodiments, a remote diagnostic component 116 can be configured to provide a status of the system 100. For example, the status may be provided in response to a remote request received by the server component 114. The status of the system 100 can then be sent to the requestor via the server component 114. In some embodiments, the remote diagnostic component 116 can be configured to monitor a capacity status of at least one of a storage component 118 or a portable storage component 120. In this way, the remote diagnostic component 116 can determine how full at least one of the storage component 118 or the portable storage component 120 may be. Accordingly, the remote diagnostic component 116 can be configured to provide or issue an alert based at least in part on a status of at least one of the storage component 118 or the portable storage component 120. In some embodiments, the alert can be based at least in part on a threshold capacity, such as 80% full, etc. The remote diagnostic component 116 can forward the alert to the server component 114, which can then communicate the alert to a recipient, via at least one of an email, text message, automated phone call, fax, customized alert, etc.

The remote diagnostic component 116 can be configured to provide a status related to one or more other features of system 100. For example, the remote diagnostic component 116 can be configured to monitor a cash supply, a fund level, a paper level, or another resource to be restocked within the system 100. Similarly to the capacity status, the remote diagnostic component 116 can be configured to provide or forward an alert to the server component 114 when a threshold is reached for at least one of the cash supply, funds, paper, or other resource. For example, if a payout component 112 can hold $100 in funds, the remote diagnostic component 116 can be configured to issue an alert when the funds reach $20 or less. In some embodiments, alerts issued by the remote diagnostic component 116 can be displayed locally by the display component 110. Additionally, fund levels, cash supply information, paper level, resource levels, etc. may be shared between one or more recycling collection payout systems.

The remote diagnostic component 116 can be configured to disable the system 100 upon remote request or based at least in part on a set of logic conditions. For example, the remote diagnostic component 116 can disable the system 100 when a storage component, such as 118 or 120, is full. The remote diagnostic component 116 can disable the system 100 when funds are low, or a paper supply (e.g., for receipts) is low. In other scenarios, the remote diagnostic component 116 can disable the system 100 when a jam or an error is detected. In this scenario, the display component 110 can be configured to display a corresponding status or error message, such as “paper jam”, “machine is full”, “out of funds”, etc. In some embodiments, the remote diagnostic component 116 can be configured to detect a break in, such as forced entry into the payroll component 112. Upon detection of forced entry, an alarm may sound. Additionally, the server component 114 can send an alert to a recipient to notify the recipient of a break in, or other status, for example. Accordingly, the remote diagnostic component 116 can thereby monitor a status of the system 100, the display component 110 can display the status of the system 100, and the server component 114 can notify recipients of the status of the system via one or more different types of alerts.

In some embodiments, a payout component 112 can be configured to provide a user with a payout. In some embodiments, the payout can be based at least in part on a number of recyclable objects received by the user. In other embodiments, the payout can be based at least in part on one or more sizes corresponding to one or more recyclable objects received. For example, a user can be paid more for a can that holds twenty ounces of fluid than for a can that holds twelve ounces of fluid. In some embodiments, the detection component 106 can be configured to detect a size associated with at least some of the one or more recyclable objects. In some embodiments, a payout can be based at least in part on a detected feature, such as a UPC, SKU, metal composition, logo, etc. For example, if the detection component 106 detects a can (e.g., because of a logo, UPC, SKU, etc.) with a metal concentration or composition higher than average, the payout component 112 can be configured to pay a different rate for that can. The server component 114 can, for example, be used to lookup such attributes related to different cans, UPCs, SKUs, logos, etc.

In some embodiments, the payout component 112 can prompt the display component 110 to display one or more payout options for the user. The input component 108 can be configured to receive one or more inputs from the user, such as a in response to the prompt from the payout component 112, for example. Accordingly, the payout component 112 can provide the user with a payout based at least in part on at least some of the one or more inputs. As an example, the payout can be based at least in part on the payout option received from the user. Further, the payout component 112 can be configured to at least one of print, provide, email, text, etc. a receipt to a user for a transaction with system 100. For example, if a user deposits ten recyclable objects within the receiving component 102 of the system 100, the recyclable objects can be detected, sorted, counted, and stored, and a receipt for $1 (e.g., @ 10 cents per recyclable object) can be printed, emailed, or communicated to the user. In some embodiments, the server component 114 can be configured to email a receipt to a user, upon notification from the payout component 112, for example. The receipt may comprise a date, a time, an amount dispensed, a number of recyclable objects deposited, a number of non-recyclable objects deposited, etc. Additionally, the server component 114 may log such information for historical tracking, etc.

In some embodiments, the payout component 112 can be configured to payout the user in a variety of ways. For example, the payout component 112 can be configured to donate money to a charity, pay cash, deposit money to a bank account, credit a credit card, credit a gift card, credit an associated user account, such as PayPal, issue a coupon, dispense a prize, etc. The display component 110 can be configured to display these various options and the input component 108 can be configured to receive one or more inputs, such as a payout option, for example. The payout component 112 can be configured to interface with the server component 114 to deposit funds to a bank account, credit card, or user account, etc. In some embodiments, a user may enter login information, which is received by the input component 108, and sent to the server component 114 to initiate funding of a transaction. In this way, by providing payouts, users are incentivized to consolidate recyclables, such as recyclable objects at a recycling collection payout system 100.

In some embodiments, the payout component 112 can be configured to issue coupons, where coupon offers are fed into the system 100 via the server component 114 and may be continually updated on a real time basis. In some embodiments, the coupons can be based at least in part on a location of the system 100. For example, if a grocery store is nearby, the payout component 112 can be configured to issue coupons to the grocery store because the store is within a radius. As another example, the coupons provided by the payout component 112 can be based at least in part on at least some of the one or more recyclable objects received by the system 100. In other words, if the system 100 or the detection component 106, for example, detects a brand or logo on a soda can being recycled, the payout component 112 can be configured to issue a coupon for that brand of soda, based at least in part on information provided by the detection component 106, such as a UPC, logo, bar code, stamp, identifying feature, SKU, etc. found or detected on at least some of the one or more received objects. Accordingly, it will be appreciated that the coupon does not necessarily have to be for a product that is recyclable; the coupon may be for a product that was non-recyclable or non-accepted in the system 100, for example. In some embodiments, the payout component 112 can be configured to issue coupons based at least in part on a marketing input, such as an input that identifies how a user learned about recycling collection payout.

In some embodiments, the server component 114 can be used to communicate the payout component 112 to an account to be paid, such as a bank account, or a user account, etc. In this scenario, the input component 108 can be configured to receive user account information or login information from the user, the server component 114 can establish a connection with the corresponding account or associate the user with the corresponding account, and the payout component 112 can payout to that account.

In some embodiments, the storage component 118 can be configured to store at least some of the one or more recyclable objects. In some embodiments, the storage component 118 can be configured to store at least some of the one or more non-recyclable or non-accepted objects. The storage component 118 can comprise a tub, a trail, a pod, etc.

In some embodiments, the portable storage component 120 can be connected to the storage component 118. The portable storage component 120 can operate as a means for maintenance to empty the system 100 of recyclables. For example, the portable storage component 120 can be a semi-trailer, and a mechanical arm or conveyer belt of the system 100 can dump or transfer at least some of the one or more recyclable objects or at least some of the one or more objects from the system 100 or the storage component 118 to the portable storage component 120. In this way, maintenance of the system 100 can be facilitated.

In some embodiments, a compacting component 122 can be configured to compact at least some of the one or more recyclable objects. This enables the system 100 to accept a larger quantity or volume of recyclables. In some embodiments, the compacting component 122 comprises one or more safety features that mitigate operation when movement is detected in the compactor 122, for example. The storage component 118 or the portable storage component 120 can be configured to house recyclables or recyclable objects after compacting. Additionally, a baling component 124 can be configured to bale at least some of the one or more recyclable objects. Accordingly, the baling component 124 facilitates easier transport of recyclable material. At least one of the storage component 118 or the portable storage component 120 can be configured to store at least some of the baled, compacted, recyclable objects.

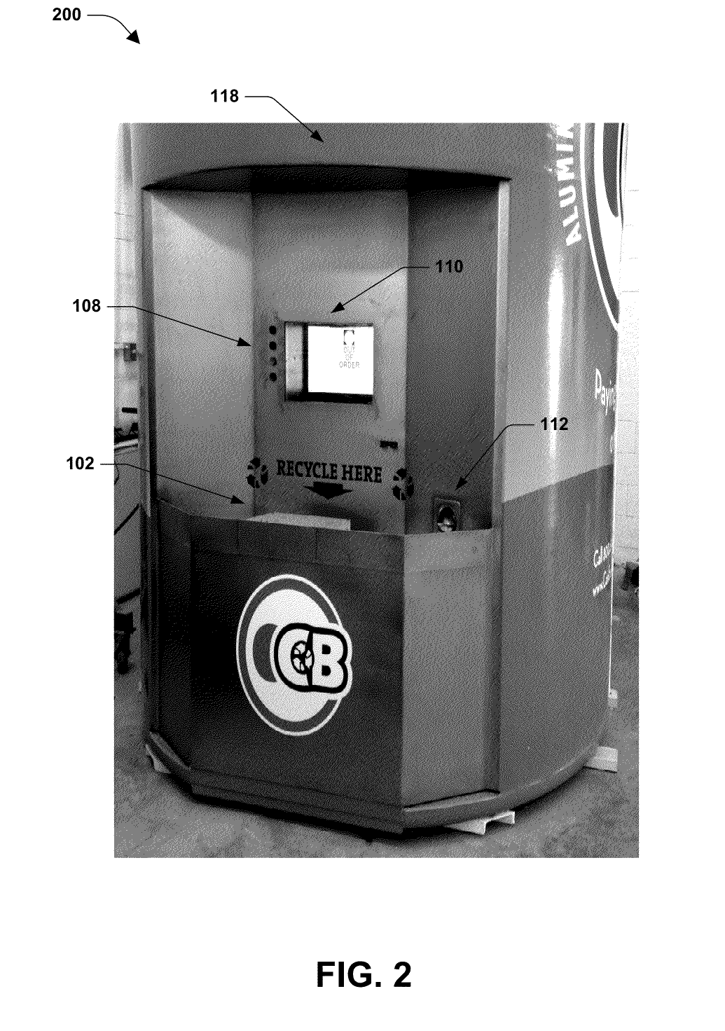

FIG. 2 is an illustration of an example system 200 for recycling collection payout, according to some embodiments. The system 200 of FIG. 2 comprises a receiving component 102, which comprises a bin or a chute, an input component 108, which comprises one or more buttons, a display component 110, which comprises a user interface (UI), a payout component 112, and a storage component 118.

In some embodiments, a user deposits one or more objects or one or more received objects into the receiving component 102, the received objects are sorted and counted (by a sorting component not shown), the user selects a payout option via input component 108, the display component 110 confirms the payout option, the recyclable objects are transported to the storage component 118, and the user receives a payout from the payout component 112.

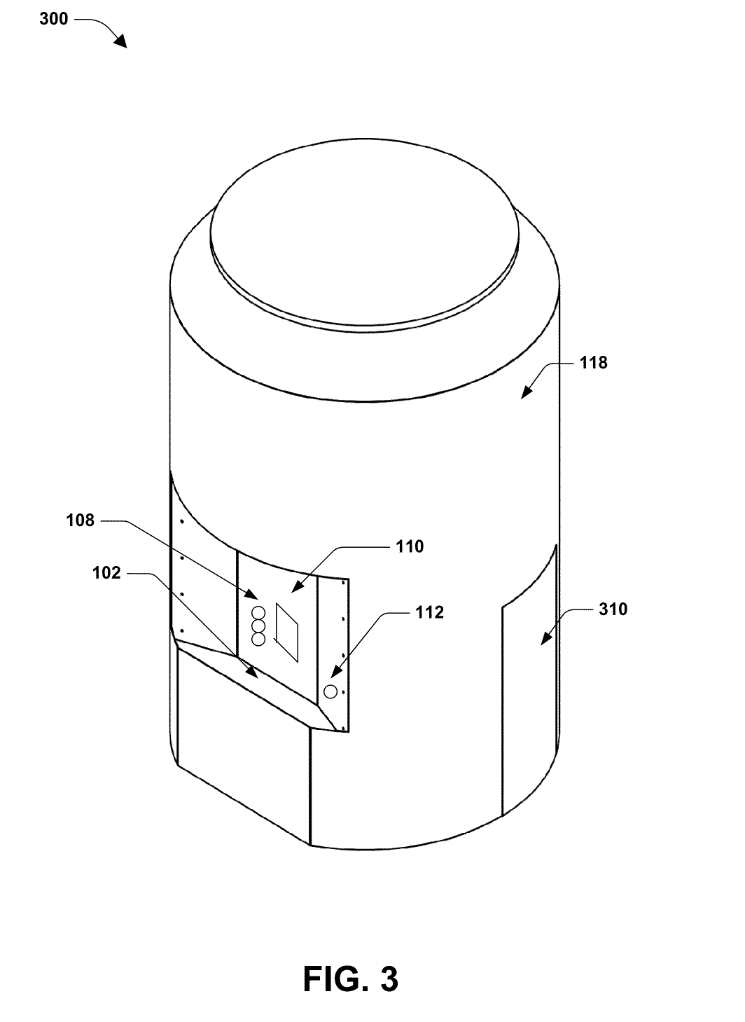

FIG. 3 is an illustration of a schematic diagram of an example system 300 for recycling collection payout, according to some embodiments. It will be appreciated that FIG. 3 is similar to FIG. 2, except that FIG. 3 comprises a door 310, behind which one or more components can be located. For example, the sorting component 104, the detection component 106, the payout component 112, the server component 114, the remote diagnostic component 116, etc. of FIG. 1 can be found when the door 310 is opened.

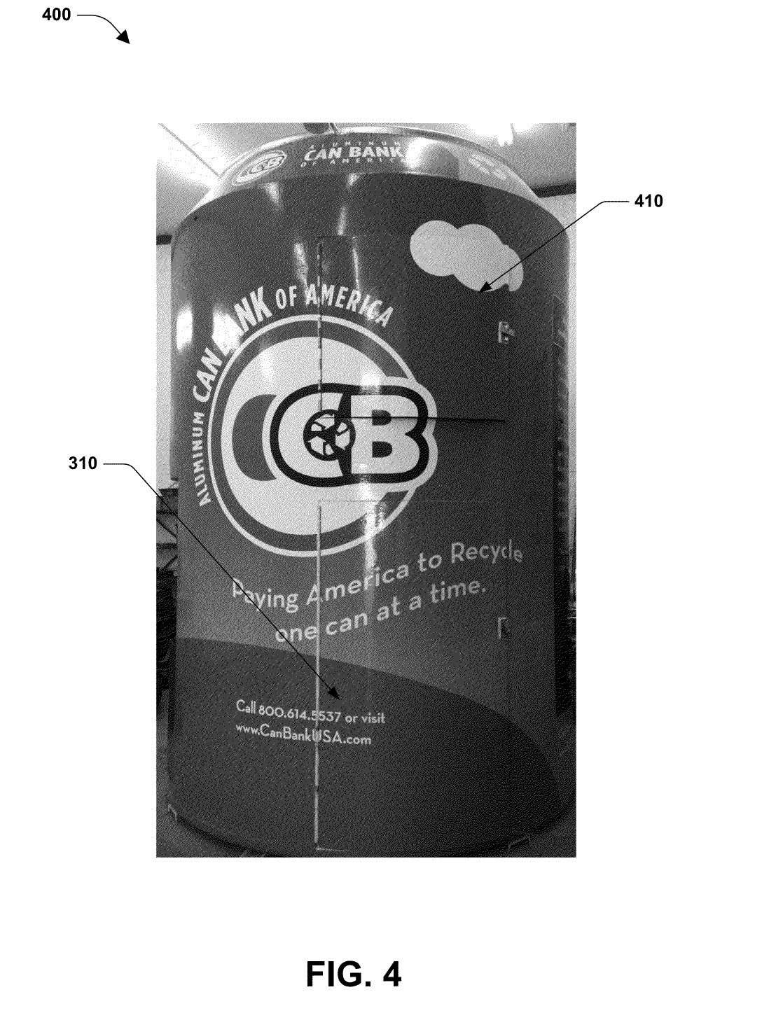

FIG. 4 is an illustration of an example system 400 for recycling collection payout, according to some embodiments. FIG. 4 illustrates a second door 410 behind which the storage component 118, compacting component 122, or baling component 124 can be located.

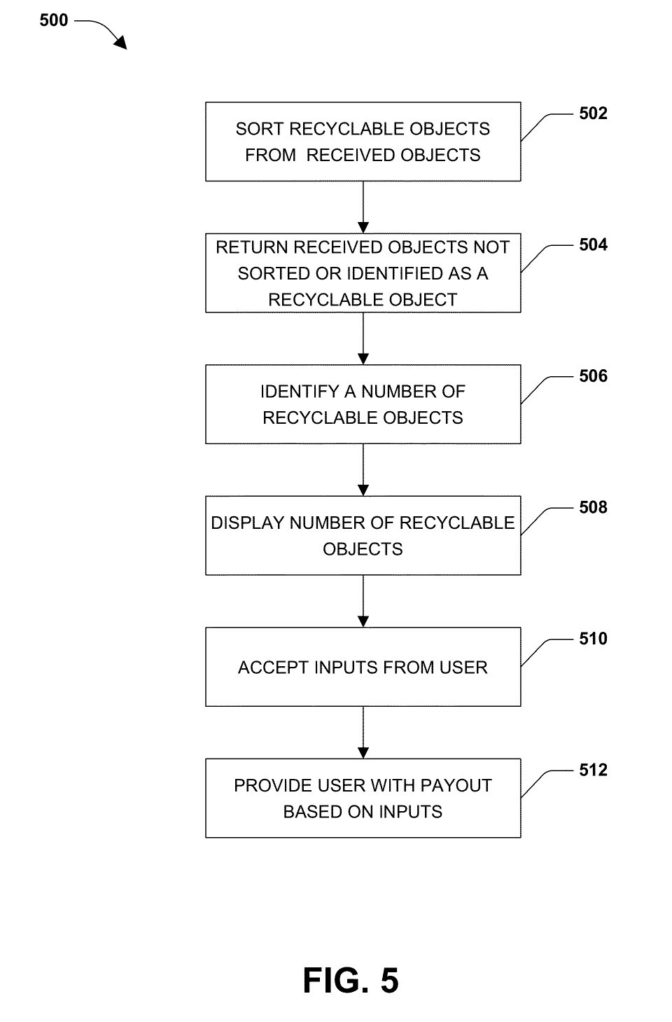

FIG. 5 is an illustration of a flow diagram of an example method 500 for recycling collection payout, according to some embodiments. At 502, one or more recyclable objects can be sorted from one or more received objects. At 504, at least some of the one or more received objects not sorted as a recyclable object can be returned, such as to a user via bin, chute, etc. At 506, a number of recyclable objects can be identified. At 508, the number of recyclable objects can be displayed, along with an estimated payout based at least in part on the number of recyclable objects. At 510, one or more inputs can be accepted from a user. At 512, the user can be provided with a payout based at least on part on at least some of the one or more inputs. In some embodiments, the payout can provided without input from the user.

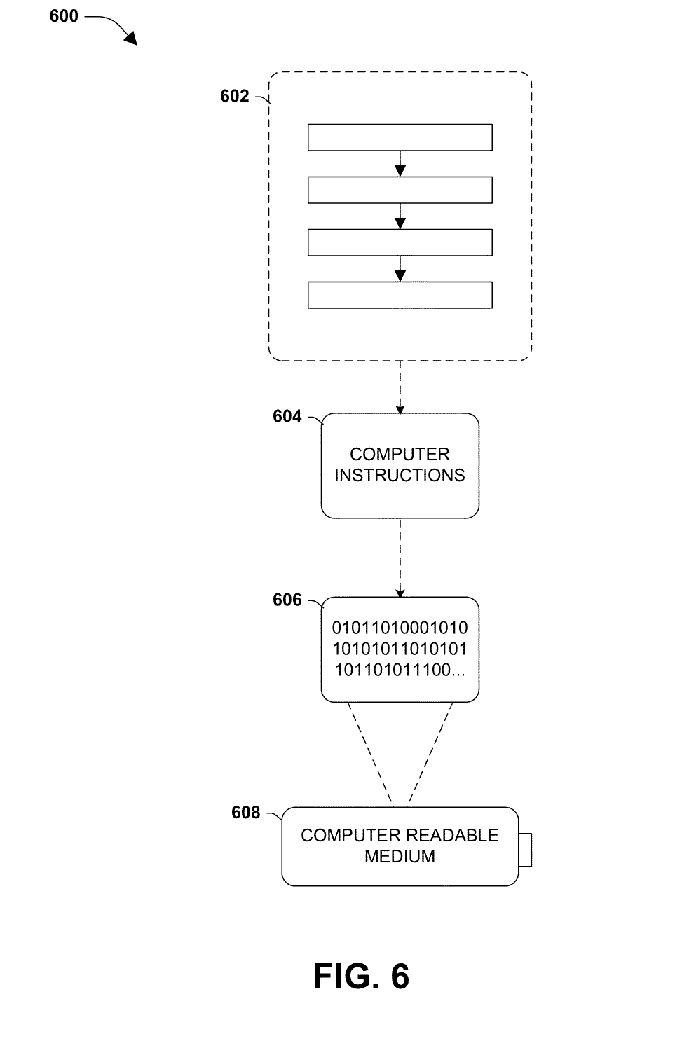

Still another embodiment involves a computer-readable medium comprising processor-executable instructions configured to implement one or more embodiments of the techniques presented herein. An embodiment of a computer-readable medium or a computer-readable device that is devised in these ways is illustrated in FIG. 6, wherein an implementation 600 comprises a computer-readable medium 608, such as a CD-R, DVD-R, flash drive, a platter of a hard disk drive, etc., on which is encoded computer-readable data 606. This computer-readable data 606, such as binary data comprising a plurality of zero's and one's as shown in 606, in turn comprises a set of computer instructions 604 configured to operate according to one or more of the principles set forth herein. In one such embodiment 600, the processor-executable computer instructions 604 are configured to perform a method 602, such as at least some of the method 500 of FIG. 5. In another embodiment, the processor-executable instructions 604 are configured to implement a system, such as at least some of the system 100, 200, 300, 400 of FIG. 1, FIG. 2, FIG. 3, or FIG. 4, respectively. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 7 and the following discussion provide a description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform particular tasks or implement particular abstract data types. Typically, the functionality of the computer readable instructions are combined or distributed as desired in various environments.

FIG. 7 illustrates a system 700 comprising a computing device 712 configured to implement one or more embodiments provided herein. In one configuration, computing device 712 includes at least one processing unit 716 and memory 718. Depending on the exact configuration and type of computing device, memory 718 may be volatile, such as RAM, non-volatile, such as ROM, flash memory, etc., or some combination of the two. This configuration is illustrated in FIG. 7 by dashed line 714.

In other embodiments, device 712 includes additional features or functionality. For example, device 712 also includes additional storage such as removable storage or non-removable storage, including, but not limited to, magnetic storage, optical storage, and the like. Such additional storage is illustrated in FIG. 7 by storage 720. In some embodiments, computer readable instructions to implement one or more embodiments provided herein are in storage 720. Storage 720 also stores other computer readable instructions to implement an operating system, an application program, and the like. Computer readable instructions are loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media is part of device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 712 includes input device(s) 724 such as keyboard, mouse, pen, voice input device, touch input device, infrared cameras, video input devices, or any other input device. Output device(s) 722 such as one or more displays, speakers, printers, or any other output device are also included in device 712. Input device(s) 724 and output device(s) 722 are connected to device 712 via a wired connection, wireless connection, or any combination thereof. In some embodiments, an input device or an output device from another computing device are used as input device(s) 724 or output device(s) 722 for computing device 712. Device 712 also includes communication connection(s) 726 to facilitate communications with one or more other devices.

According to some aspects, a system for recycling collection payout is provided, comprising a sorting component configured to sort one or more recyclable objects from one or more received objects. The system can comprise a detection component configured to identify a number of recyclable objects. The system can comprise a display component configured to prompt a user for a payout option. The system can comprise an input component configured to accept the payout option from the user. The system can comprise a payout component configured to provide the user with a payout based at least in part on the payout option accepted from the user. In some embodiments, a payout component is configured to provide a user with a receipt that identifies a coin count associated with a recycling collection payout system. Generally, the coin count can be used to count a number of coins dispensed by a recycling collection payout system or a payout component. As an example, if a customer or user brings a receipt in, claiming he or she was not paid, the coin count can be used as verification that the payout component paid the customer or the user the correct amount. Accordingly, if the customer was not paid the correct amount, the customer could be reimbursed.

In some embodiments, the system comprises a remote diagnostic component configured to provide a status of the recycling collection payout system. Additionally, the system can comprise a compacting component configured to compact at least some of the one or more recyclable objects. A portable storage component can be configured to receive at least some of the one or more recyclable objects. A baling component can be configured to bale at least some of the one or more recyclable objects. A server component can be configured to receive at least one of a time, a date, or a weather forecast and the display component can be configured to display at least one of the time, date, or the weather forecast. In some embodiments, a user can enter a zip code, such as a home zip code, using a touch pad or an input component 108. The home zip code can be used to determine where a volume of recyclable objects is coming from or to establish a location for a future recycling collection payout system.

In some embodiments, the sorting component can comprise at least one of a robotic arm, a vacuum, a conveyor belt, or a magnet. Additionally, the sorting component can be configured to return at least some of the one or more received objects not identified as a recyclable object. The detection component can comprise at least one of a bar code reader, a grate filter, a magnet, an image sensor, or a stock keeping unit (SKU) reader. A payout component can be configured to provide the user with a receipt for the payout.

According to some aspects, a system for recycling collection payout is provided, comprising a receiving component configured to receive one or more received objects. The system can comprise a sorting component configured to sort one or more recyclable objects from at least some of the one or more received objects. The sorting component can be configured to return at least some of the one or more received objects not sorted as a recyclable object. The system can comprise a detection component configured to identify a number of recyclable objects based at least in part on at least some of the one or more recyclable objects. The system can comprise a display component configured to prompt a user for one or more inputs. The system can comprise an input component configured to accept at least some of the one or more inputs from the user. The system can comprise a payout component configured to provide the user with a payout based at least in part on at least some of the one or more inputs.

In some embodiments, a server component can be configured to associate the user with a corresponding user account and the input component can be configured to accept user account information from the user. A storage component can be configured to store at least some of the one or more recyclable objects. A remote diagnostic component can be configured to provide an alert based at least in part on a status of at least one of a storage component or a portable storage component.

According to some aspects, a method for recycling collection payout is provided, comprising sorting one or more recyclable objects from one or more received objects. The method can comprise returning at least some of the one or more received objects not sorted as a recyclable object. The method can comprise identifying a number of recyclable objects. The method can comprise displaying the number of recyclable objects received and an estimated payout. The method can comprise accepting one or more inputs from a user. The method can comprise providing the user with a payout based at least in part on at least some of the one or more inputs.

In some embodiments the method comprises providing a status of the recycling collection payout system based at least in part on a remote request. The method can comprise at least one of compacting at least some of the one or more recyclable objects, baling at least some of the compacted recyclable objects, storing at least some of the baled, compacted recyclable objects, or providing the user with a receipt of the payout. Additionally, at least some of at least one of the method, the system, one or more acts of the method, one or more components of the system, etc. can be implemented at least in part via a processing unit.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which some or all of the operations are described should not be construed as to imply that these operations are necessarily order dependent. Alternative ordering will be appreciated based at least in part on this description. Further, it will be understood that not all operations are necessarily present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Also, although the disclosure has been shown and described with respect to one or more implementations, equivalent alterations and modifications will occur based at least in part on a reading and understanding of this specification and the annexed drawings. The disclosure includes all such modifications and alterations and is limited only by the scope of the following claims.

What is claimed is:

1. A system for recycling collection payout, comprising:
a sorting component configured to sort one or more recyclable objects from one or more received objects;
a detection component configured to identify a number of recyclable objects;
a display component configured to prompt a user for a payout option;
an input component configured to accept the payout option from the user; and
a payout component configured to provide the user with a payout based at least in part on the payout option accepted from the user.

2. The system of claim 1, further comprising a remote diagnostic component configured to provide a status of the recycling collection payout system.

3. The system of claim 1, further comprising a compacting component configured to compact at least some of the one or more recyclable objects.

4. The system of claim 1, further comprising a portable storage component configured to receive at least some of the one or more recyclable objects.

5. The system of claim 1, further comprising a baling component configured to bale at least some of the one or more recyclable objects.

6. The system of claim 1, further comprising a server component configured to receive at least one of a time, a date, or a weather forecast, the display component configured to display at least one of the time, date, or the weather forecast.

7. The system of claim 1, the sorting component further comprising at least one of a robotic arm, a vacuum, a vacuum blower, a conveyor belt, or a magnet.

8. The system of claim 1, the sorting component configured to return at least some of the one or more received objects not identified as a recyclable object.

9. The system of claim 1, the detection component comprising at least one of a bar code reader, a grate filter, a magnet, an image sensor, or a stock keeping unit (SKU) reader.

10. The system of claim 1, a payout component configured to provide the user with a receipt for the payout.

11. A system for recycling collection payout, comprising:
a receiving component configured to receive one or more received objects;
a sorting component configured to at least one of:
sort one or more recyclable objects from at least some of the one or more received objects; or
return at least some of the one or more received objects not sorted as a recyclable object;
a detection component configured to identify a number of recyclable objects based at least in part on at least some of the one or more recyclable objects;
a display component configured to prompt a user for one or more inputs;
an input component configured to accept at least some of the one or more inputs from the user; and
a payout component configured to provide the user with a payout based at least in part on at least some of the one or more inputs.

12. The system of claim 11, further comprising a server component configured to associate the user with a corresponding user account, the input component configured to accept user account information from the user.

13. The system of claim 11, further comprising a storage component configured to store at least some of the one or more recyclable objects.

14. The system of claim 11, further comprising a remote diagnostic component configured to provide an alert based at least in part on a status of at least one of a storage component or a portable storage component.

15. A method for recycling collection payout, comprising:
sorting one or more recyclable objects from one or more received objects;
returning at least some of the one or more received objects not sorted as a recyclable object;
identifying a number of recyclable objects;
displaying the number of recyclable objects received and an estimated payout;
accepting one or more inputs from a user; and
providing the user with a payout based at least in part on at least some of the one or more inputs.

16. The method of claim 15, further comprising providing a status of the recycling collection payout system based at least in part on a remote request.

17. The method of claim 15, further comprising compacting at least some of the one or more recyclable objects.

18. The method of claim 17, further comprising baling at least some of the compacted recyclable objects.

19. The method of claim 19, further comprising storing at least some of the baled, compacted recyclable objects.

20. The method of claim 15, further comprising providing the user with a receipt of the payout
